(19) United States
(12) Patent Application Publication
(10) Pub. No.: US 2023/0391144 A1
(43) Pub. Date: Dec. 7, 2023

(54) CONTACTLESS TIRE INSPECTION

(71) Applicant: Valvoline Licensing and Intellectual Property, LLC, Lexington, KY (US)

(72) Inventors: Adam Sworski, Ashland, KY (US); Roger England, Lexington, KY (US); Jesse Dean Dambacher, Lexington, KY (US); Matthew Bellis, Lexington, KY (US); Daniel Lau, Lexington, KY (US); Eli Crane, Lexington, KY (US); Shawn Thomas, Lexington, KY (US)

(21) Appl. No.: 18/328,592

(22) Filed: Jun. 2, 2023

Related U.S. Application Data
(60) Provisional application No. 63/348,871, filed on Jun. 3, 2022.

(51) Int. Cl. B60C 11/24; G01M 17/02; G01B 11/22

(52) U.S. Cl. CPC B60C 11/246; G01M 17/027; G01B 11/22

(57) ABSTRACT

A contactless tire inspection apparatus for tire tread depth measurement using 3D reconstruction includes a driver side (DS) measurement device (MD) and a passenger side (PS) MD. The DS MD includes a DS light source configured to, responsive to receiving a trigger signal (TS), project a first structured illumination (SI) onto a DS tire of a vehicle and at least one DS camera configured to, responsive to receiving the TS, capture DS image(s) of the first SI projected onto the DS tire for 3D reconstruction. The PS MD includes a PS light source configured to, responsive to receiving the TS, project a second SI onto a PS tire of the vehicle and at least one PS camera configured to, responsive to receiving the TS, capture PS image(s) of the second SI projected onto the PS tire for 3D reconstruction when the at least one DS camera captures DS image(s).

### CROSS-REFERENCE TO RELATED APPLICATION

The present application claims the benefit of priority under 35 U.S.C. §119 from U.S. Provisional Patent Application Ser. No. 63/348,871 entitled “Contactless Tire Inspection,” filed on Jun. 3, 2022, the disclosure of which is hereby incorporated by reference in its entirety for all purposes.

### TECHNICAL FIELD

The present disclosure generally relates to tire inspection, and more specifically relates to devices, systems, and methods for contactless tire inspection.

### BACKGROUND

Determining tire tread depth is an important factor for vehicle maintenance and ensuring that the vehicle is operating under proper conditions. Some traditional systems for measuring tire tread depth require direct contact with the measuring device or require that the vehicle under inspection be stationary. For example, some conventional devices require direct contact with the vehicle such that the vehicle drives on top of the device to actuate measurement of the tire tread depth and, after actuation, the device performs measurement of the tire tread while the vehicle is drive atop the device. In such contact devices, the life of the device is inevitably shortened due to being repeatedly driven upon with the weight of vehicles. Some of these direct contact devices also suffer from debris accumulation due to the positioning of the device such that the measurement device is orientated upwardly.

While other traditional systems for measuring tire tread depth may not require the vehicle to drive directly on top of a device, these types of systems require that the vehicle under inspection be stationary. Such systems, however, increase measurement time and may introduce manual steps that could lead to inaccurate measurements and may take significant time to perform.

The description provided in the background section should not be assumed to be prior art merely because it is mentioned in or associated with the background section. The background section may include information that describes one or more aspects of the subject technology.

### SUMMARY

According to certain aspects of the present disclosure, a contactless tire inspection apparatus for tire tread depth measurement using 3D reconstruction is provided. The contactless tire inspection apparatus includes a driver side measurement device and a passenger side measurement device. The driver side measurement device and the passenger side measurement device are spaced apart in a lateral direction and oriented in a common plane. The driver side measurement device includes a driver side light source configured to, responsive to receiving a trigger signal, project a first structured illumination onto an area of tread of a driver side tire of a vehicle at a first measurement location forwardly and laterally displaced from the driver side measurement device and at least one driver side camera configured to, responsive to receiving the trigger signal, capture one or more driver side images of the first structured illumination projected onto the driver side tire for 3D reconstruction. The passenger side measurement device includes a passenger side light source configured to, responsive to receiving the trigger signal, project a second structured illumination onto an area of tread of a passenger side tire of the vehicle at a second measurement location forwardly and laterally displaced from the passenger side measurement device and at least one passenger side camera configured to, responsive to receiving the trigger signal, capture one or more passenger side images of the second structured illumination projected onto the passenger side tire for 3D reconstruction when the least one driver side camera captures one or more driver side images of the first structured illumination projected onto the driver side tire.

In certain aspects, the first measurement location is forwardly and laterally outwardly displaced from the driver side measurement device and the second measurement location is forwardly and laterally displaced from the driver side measurement device.

In certain aspects, the first structured illumination and the second structured illumination are LED light patterns comprising an infrared wavelength.

In certain aspects, the contactless tire inspection apparatus further includes a time of flight sensor configured to monitor a field of view and initiate transmission of the trigger signal, based on detecting the vehicle passing into the field of view, to the driver side measurement device and the passenger side measurement device.

In certain aspects, at least one of the driver side measurement device and the passenger side measurement device is in communication with a pressure sensor configured to detect the vehicle applying pressure thereto and initiate transmission of the trigger signal, based on detecting the vehicle applying pressure thereto, to the at least one of the driver side measurement device and the passenger side measurement device.

In certain aspects, the contactless tire inspection apparatus further includes a license plate reader configured to, in response to receiving the trigger signal, identify a license plate of the vehicle.

In certain other aspects, a contactless tire inspection apparatus for tire tread depth measurement using 3D reconstruction is provided. The contactless tire inspection apparatus comprises a driver side measurement device, a passenger side measurement device, and a housing. The housing is configured to house the driver side measurement device and the passenger side measurement device therein. The driver side measurement device and the passenger side measurement device are spaced apart in a width dimension of the housing and oriented in a common plane. The driver side measurement device faces forwardly in a first direction angularly offset from perpendicular to the width dimension by a first angle and the passenger side measurement device faces forwardly in a second direction angularly offset from perpendicular to the width dimension by a second angle. The driver side measurement device includes a driver side light source configured to, responsive to receiving a trigger signal, project a first structured illumination onto an area of tread of a driver side tire of the vehicle at a first measurement location outwardly displaced from the housing along the first direction and at least one driver side camera configured to, responsive to receiving the trigger signal, capture one or more driver side images of the first structured illumination projected onto the driver side tire for 3D reconstruction. The passenger side measurement device includes a passenger side light source configured to, responsive to receiving the trigger signal, project a second structured illumination onto an area of tread of a passenger side tire of the vehicle at a second measurement location outwardly displaced from the housing along the second direction and at least one passenger side camera configured to, responsive to receiving the trigger signal, capture one or more passenger side images of the second structured illumination projected onto the passenger side tire for 3D reconstruction when the least one driver side camera captures one or more driver side images of the first structured illumination projected onto the driver side tire.

In certain aspects, the first angle is a positive angle and the second angle is a negative angle.

In certain aspects, the first angle and the second angle are congruent angles.

In certain aspects, the first structured illumination and the second structured illumination are LED light patterns comprising an infrared wavelength.

In certain aspects, the contactless tire inspection apparatus further includes a time of flight sensor configured to monitor a field of view and initiate transmission of the trigger signal, based on detecting the vehicle passing into the field of view, to the driver side measurement device and the passenger side measurement device.

In certain aspects, at least one of the driver side measurement device and the passenger side measurement device is in communication with a pressure sensor configured to detect the vehicle applying pressure thereto and initiate transmission of the trigger signal, based on detecting the vehicle applying pressure thereto, to the at least one of the driver side measurement device and the passenger side measurement device.

In certain aspects, the contactless tire inspection apparatus further includes a license plate reader configured to, in response to receiving the trigger signal, identify a license plate of the vehicle.

In another aspect, a contactless tire inspection apparatus for tire tread depth measurement using 3D reconstruction is provided. The contactless tire inspection apparatus comprises a driver side measurement device, a passenger side measurement device, and a housing. The housing is housing configured to house the driver side measurement device and the passenger side measurement device therein. The driver side measurement device and the passenger side measurement device are spaced apart in a width dimension of the housing and oriented in a common plane. The driver side measurement device includes a driver side light source configured to, responsive to receiving a trigger signal, project a first structured illumination onto an area of tread of a driver side tire of the vehicle at a first measurement location outwardly displaced from the housing and at least one driver side camera configured to, responsive to receiving the trigger signal, capture one or more driver side images of the first structured illumination projected onto the driver side tire for 3D reconstruction. The passenger side measurement device includes a passenger side light source configured to, responsive to receiving the trigger signal, project a second structured illumination onto an area of tread of a passenger side tire of the vehicle at a second measurement location outwardly displaced from the housing and at least one passenger side camera configured to, responsive to receiving the trigger signal, capture one or more passenger side images of the second structured illumination projected onto the passenger side tire for 3D reconstruction. The housing has a low-profile to allow placement in a travel path of the vehicle that includes the first measurement location and the second measurement location without contact with the vehicle.

In certain aspects, the first structured illumination and the second structured illumination are LED light patterns comprising an infrared wavelength.

In certain aspects, the contactless tire inspection apparatus further includes a time of flight sensor configured to monitor a field of view and initiate transmission of the trigger signal, based on detecting the vehicle passing into the field of view, to the driver side measurement device and the passenger side measurement device.

In certain aspects, at least one of the driver side measurement device and the passenger side measurement device is in communication with a pressure sensor configured to detect the vehicle applying pressure thereto and initiate transmission of the trigger signal, based on detecting the vehicle applying pressure thereto, to the at least one of the driver side measurement device and the passenger side measurement device.

In certain aspects, the contactless tire inspection apparatus further includes a license plate reader configured to, in response to receiving the trigger signal, identify a license plate of the vehicle.

In certain aspects, the driver side measurement device faces forwardly in a first direction angularly offset from perpendicular to the width dimension by a first angle and the passenger side measurement device faces forwardly in a second direction angularly offset from perpendicular to the width dimension by a second angle.

In certain aspects, the first measurement location is forwardly and laterally outwardly displaced from the driver side measurement device and the second measurement location is forwardly and laterally displaced from the driver side measurement device.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitutes a part of this specification, illustrate disclosed embodiments and together with the description serve to explain the principles of the disclosed embodiments. In the drawings:

FIG. 1 is a perspective view illustrating an example system for contactless tire inspection according to certain aspects of the disclosure.

FIG. 2A is a perspective view illustrating an example inspection device for contactless tire inspection according to certain aspects of the disclosure.

FIG. 2B is a front exploded view of the example inspection device according to certain aspects of the disclosure.

FIG. 3 is a perspective view with a housing of the inspection device removed to illustrate the measurement devices and license plate reader according to certain aspects of the disclosure.

FIG. 4 is a top view of the inspection device with housing portions removed to illustrate internal components of the measurement devices and license plate reader according to certain aspects of the disclosure.

FIG. 5 is perspective view of the inspection device with housing portions removed to illustrate internal components of the measurement devices and license plate reader according to certain aspects of the disclosure.

FIG. 6 is a perspective view of an embodiment of the license plate reader with portions removed to illustrate internal components of the license plate reader according to certain aspects of the disclosure.

FIG. 7 is a perspective view of an alternative embodiment of the license plate reader with portions removed to illustrate internal components of the alternative embodiment of the license plate reader according to certain aspects of the disclosure.

FIG. 8 illustrates key attributes of the inspection device that are used for 3D reconstruction according to certain aspects of the disclosure.

FIG. 9 is a detailed portion of FIG. 8 according to certain aspects of the disclosure.

FIG. 10 illustrates six degrees of freedom of motion for the cameras and light source of the measurement devices.

FIG. 11 illustrates an exemplary diagram of six degrees of freedom of motion.

FIGS. 12A-12G are exemplary complex, two-dimensional pattern pairs of a structured illumination (e.g., left column depicting the driver side projection and the right column depicting the passenger side projection), which the light source projects according to certain aspects of the disclosure.

FIG. 12H illustrates a complex, two-dimensional pattern of a structured illumination with embedded information according to certain aspects of the disclosure.

FIG. 13 is a top view illustrating field of view of the measurement devices and license plate reader according to certain aspects of the disclosure.

FIG. 14 is a side view illustrating field of view of the measurement devices and license plate reader according to certain aspects of the disclosure.

FIG. 15 illustrates an alternative embodiment of a passenger side measurement device of an inspection device in which the passenger side measurement device includes one passenger side camera (e.g., instead of two cameras) and one passenger side light source and a driver side measurement device includes one driver side camera (e.g., instead of two cameras) and one driver side light source.

FIG. 16 illustrates an example architecture for contactless tire inspection according to certain aspects of the disclosure.

FIG. 17 is a block diagram illustrating the example server and inspection device from the architecture of FIG. 16 according to certain aspects of the disclosure.

FIG. 18 is a block diagram illustrating an example computer system with which the server and the inspection device can be implemented.

FIG. 19 is a top view illustrating field of view of the inspection devices and measurements zones according to certain aspects of the disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

### General Overview

The disclosed technology provides devices, systems, and methods for contactless tire inspection. For example, the subject technology enables non-contact tire tread depth measurement with improved efficiency and accuracy on vehicles that are in motion or stationary. In certain aspects, the device for contactless tire inspection includes at least one light source to project a structured illumination, such as, but not limited to, an LED light pattern, with a particular brightness, wavelength, and pattern, onto a portion of a tire on a moving vehicle, and at least one camera to detect the projected structured illumination on the tire for constructing a three dimensional image of the tire to determine tire tread depth of the tire. In certain aspects, the tire tread evaluation area covers a full width of the tire and a circumferential portion that may be determined by the radius of the tire.

In certain aspects, the light source projects a structured illumination, such as, but not limited to, an LED light pattern with an infrared wavelength onto a tire of a vehicle. The structured illumination with the infrared wavelength can eliminate any visible light that may be hazardous, reduce the reduction in the signal-to-noise ratio caused by ambient light, and maintain appropriate image sensor sensitivity. For example, in certain aspects, the brightness of the structured illumination is designed to ensure sufficient light availability for short camera exposures. In certain aspects, camera exposure time is on the order of a few hundred microseconds. In certain aspects, the light source projects the structured illumination as a complex, two-dimensional pattern. In certain aspects, the structured illumination, including the complex, two-dimensional pattern, can enable epi-polar rectification, can facilitate correspondence matching between pixels on each image sensor, and can provide clear profiles for determining the tire tread depth.

In certain aspects, the device for contactless tire inspection includes a touchless trigger and does not require direct contact with the device to trigger actuation of the device. For example, in certain instances, a focal length is associated with the projected structured illumination so that when the at least one camera detects that the projected structured illumination projected onto the tire, that is within a predetermined measurement zone, is in focus, the at least one camera is actuated and begins capturing images. In certain aspects, the at least one camera captures the images at a rate range of 20 to 34 images per second although other image rates are within the scope of the present disclosure. In certain aspects, a first camera and a second camera are implemented to capture the images at a rate range of 20 to 34 image pairs per second. Once the images are captured, a best image is determined and used to generate a 3D image of the tire for determining the tire tread depth. In certain aspects, the subject technology is configured to determine tire tread depths of 7/32 inches or less.

The device is positioned with respect to the vehicle such that the vehicle will pass over the device without requiring direct contact with the device for actuation, as will be explained in more detail below. In certain aspects, the at least one camera is positioned to be off-axis with respect to the vehicle such that the at least one camera is neither orthogonal to or parallel to the longitudinal axis of the vehicle in the forward direction.

In certain aspects, the subject technology includes a self-calibration feature that periodically or continuously monitors at least one predetermined fixed object, such as, but not limited to, a placard, located on a nearby surface, which may be a vertical surface, to determine whether current readings are within a specified range to ensure accurate and precise image captures for determining tire tread depth. Based on such monitoring results, the subject technology is configured to provide a self-diagnostic report that identifies when cameras are obstructed, when calibration is off, when the system is damaged (e.g., is hit or takes a shock), when a vehicle makes incidental contact, and other diagnostically appropriate situations.

In certain aspects, the system is capable of identifying a license plate of a vehicle for linking tire tread data to the vehicle associated with the license plate. In certain aspects, the device includes a license plate camera for capturing the license plate of the vehicle. The license plate camera can be positioned to capture a front license plate of the vehicle and/or a rear license plate of the vehicle. In certain aspects, the license plate is matched or linked with the vehicle by using vehicle registration data associated with the vehicle identification number (VIN) of the vehicle. In certain aspects, the system can communicate with a service center point of sale system to obtain the VIN of the vehicle.

In certain aspects, the device includes an air knife to clean a window protecting the at least one camera. In certain aspects, the air knife is positioned adjacent to the window and is configured to selectively blow a burst of air over the window shield to remove any debris thereon. In certain aspects, the air knife is actuated based on a particular event. For example, the at least one camera is configured to monitor or observe conditions of the window shield and determine whether debris has accumulated thereon. The air knife can be triggered, for example, when the at least one camera determines a degradation in transmitted light, when changes in the uniformity of light is determined, and when other indications are determined that the window shield is unclean. In certain aspects, in addition to a burst of air, the air knife is configured to release a chemical cleaner onto the window shield for more robust cleaning. For example, the chemical cleaner may be a solvent to facilitate removal of oil films, may be an acidic solution to facilitate removal of salt deposits, or may be any other type of chemical cleaner for removing particular debris.

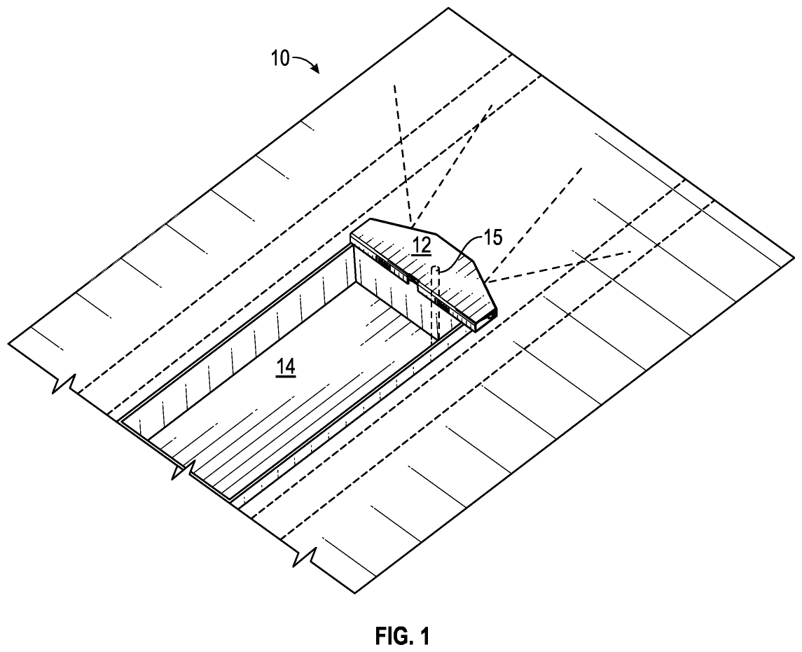

FIG. 1 illustrates an example system 10 for contactless tire inspection of a vehicle. In particular, the system 10 includes an inspection apparatus or device 12 configured to inspect one or more tires of a vehicle for tire tread depth measurement without physical contact between the inspection device 12 and the vehicle tires. In certain aspects, the inspection device 12 is located at a service pit 14. The inspection device 12 can be located, for example, at ground level (e.g., on a service floor or embedded at least partially in the service floor) at a leading edge or entrance of the service pit 14 from which a vehicle approaches. The system 10 may also include one or more service lines 15, for example, electrical cables for supplying external power to the inspection device 12 and facilitating data communication between the inspection device 12 and a server or other remote computing device for tire tread depth measurement and fluid conduits for supplying air to the inspection device 12. The one or more service lines 15 can be routed below or at ground level through the ground service floor surrounding the service pit 14. Such a configuration can eliminate potential hazards above the ground service floor around the service pit 14. While the inspection device 12 is illustrated at the service pit 14 for ease of description, it should be understood that in other aspects the inspection device 12 may be positioned in other environments that provide appropriate spacing and views of the tires of the vehicle. For example, the inspection device 12 may be, but is not limited to being, disposed on the floor of a service bay without a service pit, including at the entrance or exit of the service bay or mounted to a service lift.

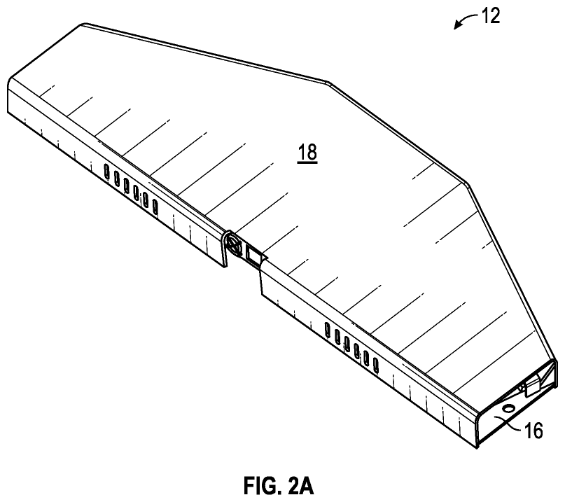

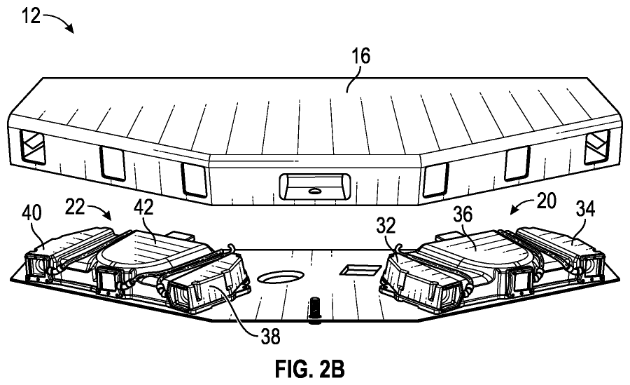

With reference to FIGS. 2 and 3, the inspection device 12 includes one or more measurement devices 20, 22 housed in a housing 16. The housing 16 is designed to protect the components of the inspection device 12 and, in certain aspects, includes a strike plate 18 to protect against unintentional vehicle strikes and other such potential contact damage. In certain aspects, the strike plate 18 is integral with the housing 16 while in other aspects the strike plate 18 is a separate cover that may be removable. With particular reference to FIG. 3, the inspection device 12 includes a passenger side measurement device 20 and a driver side measurement device 22. As illustrated, in certain aspects, the inspection device 12 optionally includes a license plate reader 24 for identifying a license plate of the vehicle. Accordingly, in certain other aspects, the inspection device 12 does not include the license plate reader 24.

The passenger side measurement device 20 includes a passenger side housing 26 for housing the components thereof. Similarly, the driver side measurement device 22 includes a driver side housing 28 and the license plate reader 24 includes a reader housing 30 for housing the respective components thereof. In certain aspects, the passenger side housing 26, the driver side housing 28, and the reader housing 30 are waterproof. In certain aspects, the passenger side housing 26, the driver side housing 28, and the reader housing 30 have an IP67 waterproof rating.

In certain aspects, the housing 16 has a body with a unitary construction, including one or more compartments, each configured for securely and removably mounting one of the passenger side measurement device 20, the driver side measurement device 22 and the license plate reader 24 therein. For example, the compartments of the housing 16 may be shaped and/or sized to accommodate, respectively, the passenger side measurement device 20, the driver side measurement device 22 and the license plate reader 24 therein and may include apertures or mounting members that allow the passenger side housing 26, the driver side housing 28, and the reader housing 30 to be mounted to the housing 16 using screws or other fasteners. In other aspects, the passenger side measurement device 20, the driver side measurement device 22 and the license plate reader 24 of the inspection device 12 may be provided separately without the housing 16. The passenger side measurement device 20, the driver side measurement device 22 and the license plate reader 24 also may be configured to detachably attach to one another. As a result, the inspection device 12 can be modular and the passenger side measurement device 20, the driver side measurement device 22, and the license plate reader 24 may be positioned independently of each other at different locations in the same environment.

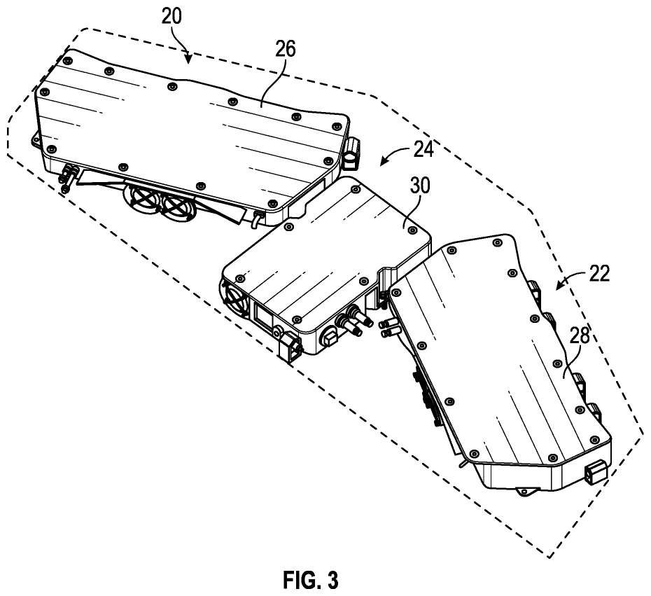

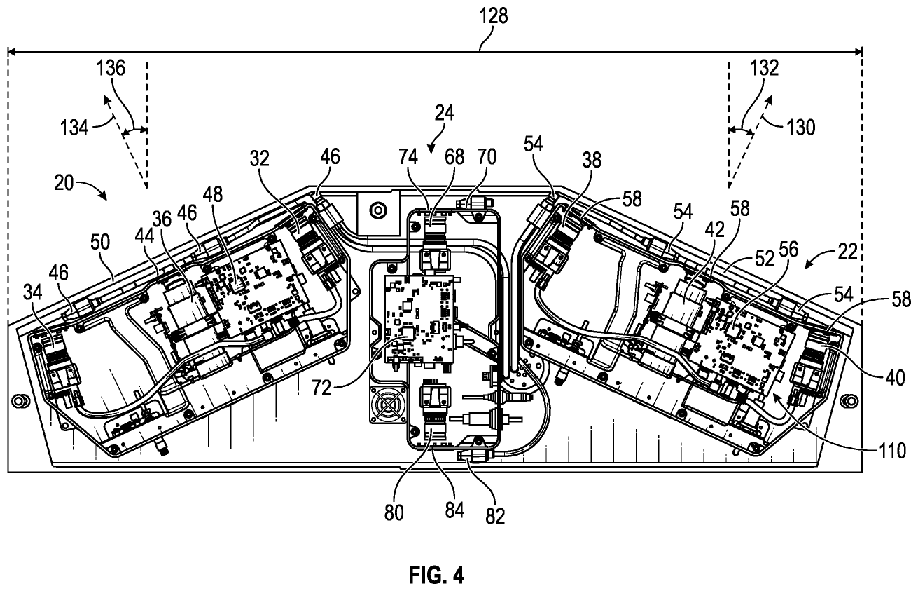

FIGS. 4 and 5 illustrate the inspection device 12 with portions removed to illustrate the passenger side measurement device 20, the driver side measurement device 22, and, optionally, the license plate reader 24 positioned within the housing 16. Portions of the passenger side housing 26, the driver side housing 28, and the reader housing 30 are removed to illustrate internal components. In certain aspects, the passenger side measurement device 20 includes a first passenger side camera 32, a second passenger side camera 34, and a passenger side light source 36 disposed therebetween. As will be described in more detail below, the first passenger side camera 32 and the second passenger side camera 34 are configured to capture images of the passenger side tires (e.g., front and rear) of the vehicle under inspection. Although the passenger side measurement device 20 is depicted with the first passenger side camera 32 and the second passenger side camera 34, it should be understood that, in certain aspects, the passenger side measurement device 20 can include the passenger side light source 36 and one of the first passenger side camera 32 and the second passenger side camera 34 instead of both cameras. The passenger side light source 36 is configured to project a spatially varying pattern onto the passenger side tires of the vehicle under inspection, individually, as will be described in more detail below.

The driver side measurement device 22 similarly includes a first driver side camera 38, a second driver side camera 40, and a driver side light source 42 disposed therebetween. As will be described in more detail below, the first driver side camera 38 and the second driver side camera 40 are configured to capture images of the driver side tires (e.g., front and rear) of the vehicle under inspection. Similar to the passenger side measurement device 20, while the driver side measurement device 22 is depicted with the first driver side camera 38 and the second driver side camera 40, it should be understood that, in certain aspects, the driver side measurement device 22 can include the driver side light source 42 and one of the first driver side camera 38 and the second driver side camera 40 instead of both cameras. The driver side light source 42 is configured to project a spatially varying pattern onto the driver side tires of the vehicle under inspection, individually, as will be described in more detail below.

The passenger side measurement device 20 includes a passenger side time of flight sensor 44 disposed adjacent the passenger side light source 36 and a plurality of passenger side air knives 46. The passenger side measurement device 20 also includes a passenger side processor 48 in communication with the first passenger side camera 32, the second passenger side camera 34, the passenger side light source 36, the passenger side time of flight sensor 44, and the plurality of passenger side air knives 46. The passenger side housing 26 of the passenger side measurement device 20 includes a plurality of passenger side windows 50. Each passenger side window of the plurality of passenger side windows 50 is correspondingly disposed adjacent each of the first passenger side camera 32, the second passenger side camera 34, the passenger side light source 36, and the passenger side time of flight sensor 44 to allow viewing access outside of the passenger side measurement device 20. In certain aspects, a single passenger side window is disposed adjacent to both the passenger side light source 36 and the passenger side time of flight sensor 44 instead of a separate passenger side window for each.

Additionally, each passenger side air knife of the plurality of passenger side air knives 46 is correspondingly disposed adjacent each passenger side window of the plurality of passenger side windows 50 exteriorly of the passenger side measurement device 20. Each passenger side air knife of the plurality of passenger side air knives 46 is configured to selectively blow a burst of air over its corresponding passenger side window of the plurality of passenger side windows 50 to remove any debris thereon. In certain aspects, each passenger side air knife of the plurality of passenger side air knives 46 is actuated based on a particular event. For example, one of the first passenger side camera 32 or the second passenger side camera 34 or both, is configured to monitor or observe conditions of the corresponding passenger side window of the plurality of passenger side windows 50 for determining whether debris has accumulated thereon in order to selectively trigger the plurality of passenger side air knives 46 to blow a burst of air. The air knife can be triggered, for example, when one of the first passenger side camera 32 or the second passenger side camera 34 or both, determines a degradation in transmitted light, when changes in the uniformity of light is determined, and when other indications are determined that a passenger side camera is unclean. In certain aspects, in addition to a burst of air, each air knife is configured to release a chemical cleaner onto its corresponding passenger side camera for more robust cleaning. For example, the chemical cleaner may be a solvent to facilitate removal of oil films, may be an acidic solution to facilitate removal of salt deposits, or may be any other type of chemical cleaner for removing particular debris.

Similarly, the driver side measurement device 22 includes a driver side time of flight sensor 52 disposed adjacent the driver side light source 42 and a plurality of driver side air knives 54. The driver side measurement device 22 also includes a driver side processor 56 in communication with the first driver side camera 38, the second driver side camera 40, the driver side light source 42, the driver side time of flight sensor 52, and the plurality of driver side air knives 54. The driver side housing 28 of the driver side measurement device 22 includes a plurality of driver side windows 58. Each driver side window of the plurality of driver side windows 58 is correspondingly disposed adjacent each of the first driver side camera 38, the second driver side camera 40, the driver side light source 42, and the driver side time of flight sensor 52 to allow viewing access outside of the driver side measurement device 22. In certain aspects, a single driver side window is disposed adjacent to both the driver side light source 42 and the driver side time of flight sensor 52 instead of a separate driver side window for each.

Additionally, each driver side air knife of the plurality of driver side air knives 54 is correspondingly disposed adjacent each driver side window of the plurality of driver side windows 58 exteriorly of the driver side measurement device 22. Each driver side air knife of the plurality of driver side air knives 54 is configured to selectively blow a burst of air over its corresponding driver side window of the plurality of driver side windows 58 to remove any debris thereon. In certain aspects, each driver side air knife of the plurality of driver side air knives 54 is actuated based on a particular event. For example, one of the first driver side camera 38 or the second driver side camera 40 or both, is configured to monitor or observe conditions of the corresponding driver side window of the plurality of driver side windows 58 for determining whether debris has accumulated thereon in order to selectively trigger the plurality of driver side air knives 54 to blow a burst of air. The air knife can be triggered, for example, when one of the first driver side camera 38 or the second driver side camera 40 or both, determines a degradation in transmitted light, when changes in the uniformity of light is determined, and when other indications are determined that a driver side camera is unclean. In certain aspects, in addition to a burst of air, each air knife is configured to release a chemical cleaner onto its corresponding driver side camera for more robust cleaning. For example, the chemical cleaner may be a solvent to facilitate removal of oil films, may be an acidic solution to facilitate removal of salt deposits, or may be any other type of chemical cleaner for removing particular debris.

The passenger side measurement device 20 includes a passenger side heat sink 60 fluidly connected to internal heat sources within the passenger side housing 26 of the passenger side measurement device 20 to dissipate heat therefrom. The passenger side heat sink 60 can include a passenger side cooling fan 62. Similarly, the driver side measurement device 22 includes a driver side heat sink 64 fluidly connected to internal heat sources within the driver side housing 28 of the driver side measurement device 22 to dissipate heat therefrom. The driver side heat sink 64 can include a driver side cooling fan 66.

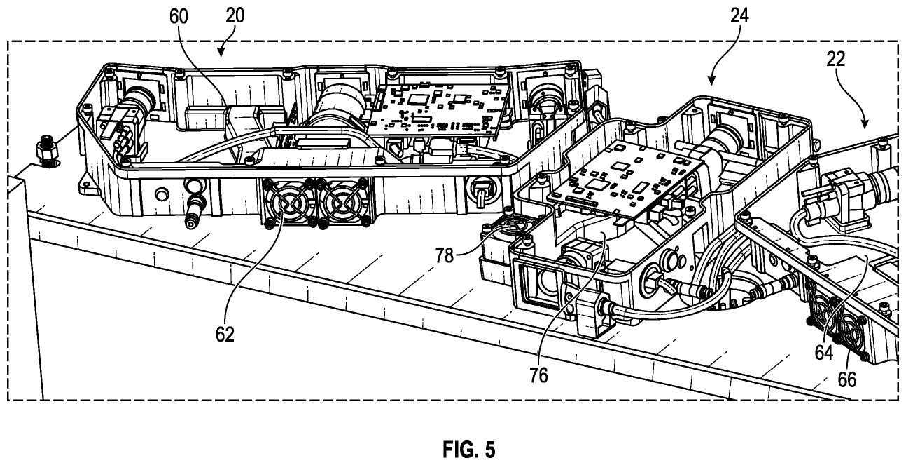

Referring to FIG. 6, the license plate reader 24 includes a license plate reader camera 68 and a license plate reader air knife 70. The license plate reader 24 also includes a license plate reader processor 72 in communication with the license plate reader camera 68 and the license plate reader air knife 70. The reader housing 30 of the license plate reader 24 includes a license plate reader window 74 disposed adjacent to the license plate reader camera 68 to allow viewing access outside of the license plate reader 24. The license plate reader air knife 70 is disposed adjacent to the license plate reader window 74 exteriorly of the license plate reader 24. The license plate reader air knife 70 is configured to selectively blow a burst of air over the license plate reader window 74 to remove any debris thereon. In certain aspects, the license plate reader air knife 70 is actuated based on a particular event. For example, the license plate reader camera 68 is configured to monitor or observe conditions of the license plate reader window 74 for determining whether debris has accumulated thereon in order to selectively trigger the license plate reader air knife 70 to blow a burst of air. The license plate reader air knife 70 can be triggered, for example, when the license plate reader camera 68 determines a degradation in transmitted light, when changes in the uniformity of light is determined, and when other indications are determined that the license plate reader camera 68 is unclean. In certain aspects, in addition to a burst of air, the license plate reader air knife 70 is configured to release a chemical cleaner onto the license plate reader window 74 for more robust cleaning. For example, the chemical cleaner may be a solvent to facilitate removal of oil films, may be an acidic solution to facilitate removal of salt deposits, or may be any other type of chemical cleaner for removing particular debris.

The license plate reader 24 includes a license plate reader heat sink 76 fluidly connected to internal heat sources within the reader housing 30 of the license plate reader 24 to dissipate heat therefrom. The license plate reader heat sink 76 can include a license plate reader cooling fan 78.

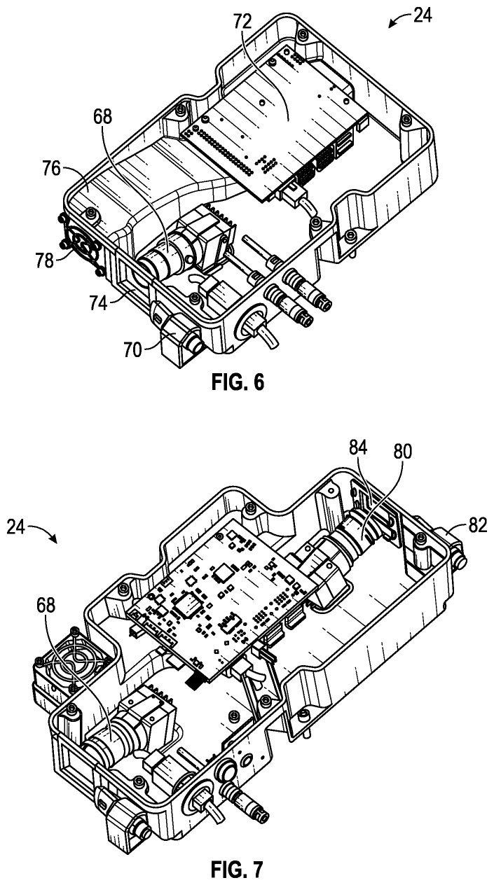

FIG. 7 illustrates an alternative embodiment of the license plate reader 24, which is exemplarily depicted in FIGS. 4 and 5. In this embodiment, the license plate reader 24 includes a second license plate reader camera 80 and a second license plate reader air knife 82, both in communication with the license plate reader processor 72. In certain aspects, the reader housing of this embodiment of the license plate reader 24 includes a second license plate reader window 84 disposed adjacent to the second license plate reader camera 80 to allow viewing access outside of the license plate reader 24. In such an embodiment, while similar components operate as described with respect to the embodiment illustrated in FIG. 6, the second license plate reader camera 80 can be positioned to capture a rear license plate of the vehicle as the vehicle is driving away from the inspection device 12.

With reference to FIGS. 1 and 4, the passenger side measurement device 20 and the driver side measurement device 22 are disposed in a common plane in the housing 16 and are spaced apart in a lateral direction corresponding to a width dimension of the housing 16 with the license plate reader 24 positioned between them. Each of the passenger side measurement device the driver side measurement device 22, and the license plate reader 24 incorporate a low profile such that their orientation within the housing 16 reduces the overall height of the inspection device 12, which is, thus, also low profile. The low profile design of the inspection device 12 allows for effective positioning at the service pit 14. Accordingly, the overall height of inspection device 12 incorporating the low profile provides a clearance for a vehicle to pass over the inspection device 12.

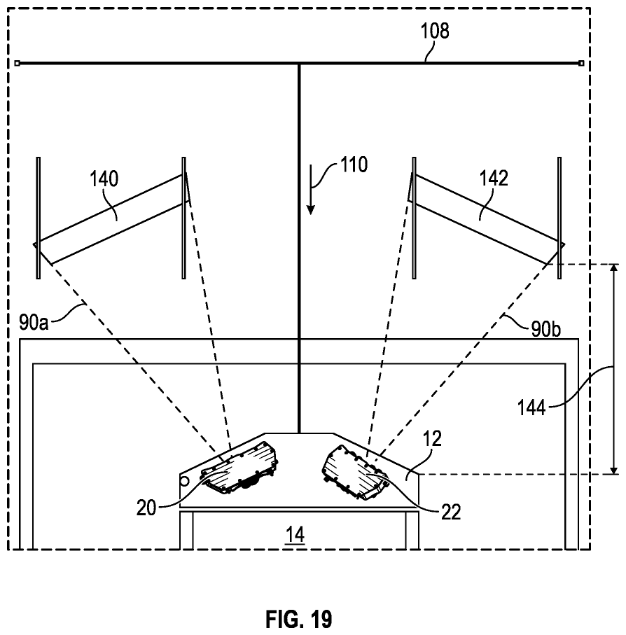

Referring to FIGS. 4, 13, and 19, the passenger side measurement device 20 and the driver side measurement device 22 both are disposed facing forwardly toward an area located ahead of the inspection device 12. The passenger side measurement device 20 is oriented in a forward direction that is angularly offset by a negative angle from a central axis of the housing 16 that is perpendicular to the width dimension of the housing 16. The driver side measurement device 22 is oriented in a forward direction that is angularly offset by a positive angle from the central axis of the housing 16 that is perpendicular to the width dimension of the housing 16. As illustrated, in certain aspects, the passenger side measurement device 20 and the driver side measurement device 22 may be angularly offset by congruent angles that have the same absolute value. The passenger side measurement device 20 has a passenger side field 90a of view that forms one or more passenger side measurement zones 140 for a passenger side tire 122 of a vehicle and the driver side measurement device 22 has a driver side field of view 90b that forms one or more driver side measurement zones 142 for a drive side tire 114 of the vehicle. The passenger side measurement zone 140 is a trapezoidal area of overlap created by the intersections of the field of views of the first passenger side camera 32 and the second passenger side camera 34, and the projected structured illumination 86 by the passenger side light source 36. Similarly, the driver side measurement zone 142 is a trapezoidal area of overlap created by the intersections of the field of views of the first driver side camera 38 and the second driver side camera 40, and the projected structured illumination 86 by the driver side light source 42. The top and bottom, in a vertical direction, of these trapezoids (base 1 and base 2) are perpendicular to the light source projection axis, and offset a certain distance 144 from light sources 36, 42. This distance 144 can be one meter, but is not limited to being one meter and can be any appropriate distance that is a function of the light source design and camera setup. Desired distance will be one that provides adequate resolution to allow for accurate pixel identification during 3D reconstruction process. The height of trapezoid is also a function of light source design and camera setup, it is determined by choosing the min and max distance from light source allowable without causing loss of pixel resolution. Each measurement zone is spaced forwardly and laterally outwardly from the housing 16. In certain aspects, the passenger side and driver side measurement zones may be equidistant from the inspection device 12. In this way, the inspection device 12 can be located along a travel path of the vehicle for carrying out inspection of a passenger side tire and/or a driver side tire of the vehicle as the vehicle approaches the inspection device 12 without coming into contact with the vehicle or its tires. Further, the inspection device 12 can carry out inspection of a set of passenger and driver side tires, for example a forward or rear set of passenger and driver side tires, at the same time if so desired.

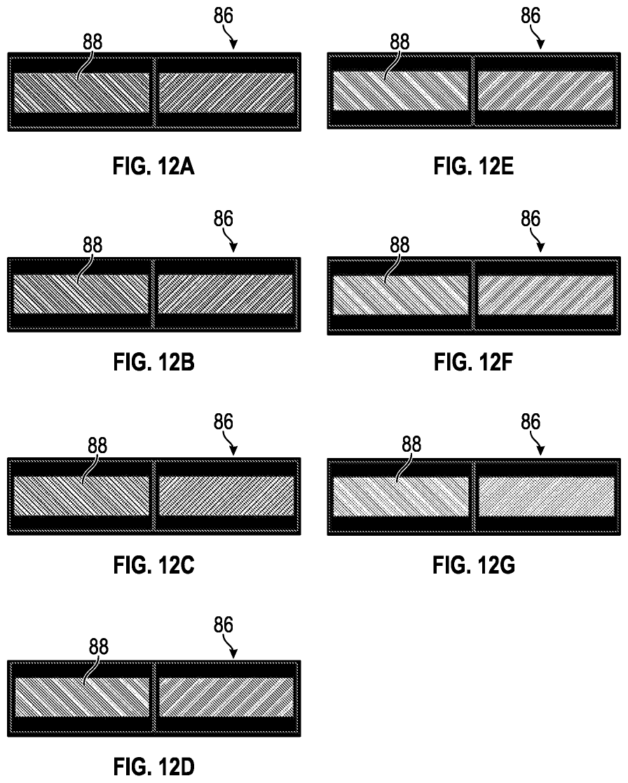

As described above, the passenger side light source 36 of the passenger side measurement device 20 and the driver side light source 42 of the driver side measurement device 22 are each configured to project a structured illumination 86 onto a passenger side tire and a driver side tire of the vehicle, respectively, when the tires are located in their respective measurement zones. In addition, the passenger side cameras 32 and 34 and the driver side cameras 38 and 40 are configured to capture images of the structured illumination 86 projected onto the tires for creating a 3D model of the surface of the tires to determine tire tread depth of the tires. In certain aspects, the passenger side light source 36 and the driver side light source 42 may be LED pattern projectors. The structured illumination 86 has a generated light pattern 88, such as lines, stripes, grid, or cross-hair matrix. In certain aspects, the pattern 88 may a diagonal striped pattern (see FIG. 12A, for example). Because the passenger side measurement device 20 and the driver side measurement device 22 are mirror images of each other with respect to the inspection device 12, the generated pattern 88 of the structured illumination 86 projected by the passenger side light source 36 (e.g., right column in FIGS. 12A-12G) is the mirror of the generated pattern 88 of the structured illumination 86 projected by the driver side light source 42 (e.g., left column in FIGS. 12A-12G). The generated pattern 88 of the structured illumination 86 depicted in FIG. 12A is exemplary of a stripped pattern, and it will be understood by those skilled in the art that other stripped patterns may be used, including, but not limited to, the patterns depicted in FIGS. 12B-12G. In order to ensure accurate measurements of the tire tread depth, the first passenger side camera 32, the second passenger side camera 34, and the passenger side light source 36 of the passenger side measurement device 20 are configured with specific baselines with respect to each other to enable 3D reconstruction of surfaces of the passenger side tire using triangulation techniques. Similarly, as the driver side measurement device 22 is a mirror image of the passenger side measurement device 20 with respect to the inspection device 12, the first driver side camera 38, the second driver side camera 40, and the driver side light source 42 of the driver side measurement device 22 are configured with specific baselines with respect to each other to enable 3D reconstruction of surfaces of the driver side tire by triangulation.

With reference to FIG. 12H, in certain aspects, the structured illumination 86 includes embedded information 89. The embedded information 89 is configured to allow lines in the generated pattern 88 of the structured illumination 86 to be identified such that discontinuations in a particular line can be easily matched. Being able to identify a particular line with the embedded information 89 allows for a higher density of lines within a generated pattern 88 and provides more efficiency since lines can be easily identified. Accordingly, the higher density of lines within a generated pattern 88 results in a higher density 3D model of the surface of the tires to determine tire tread depth of the tires.

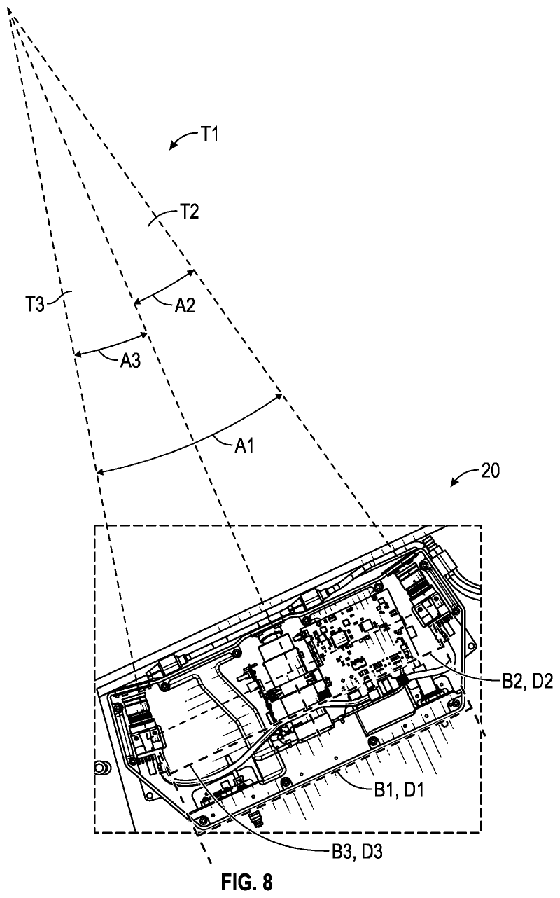

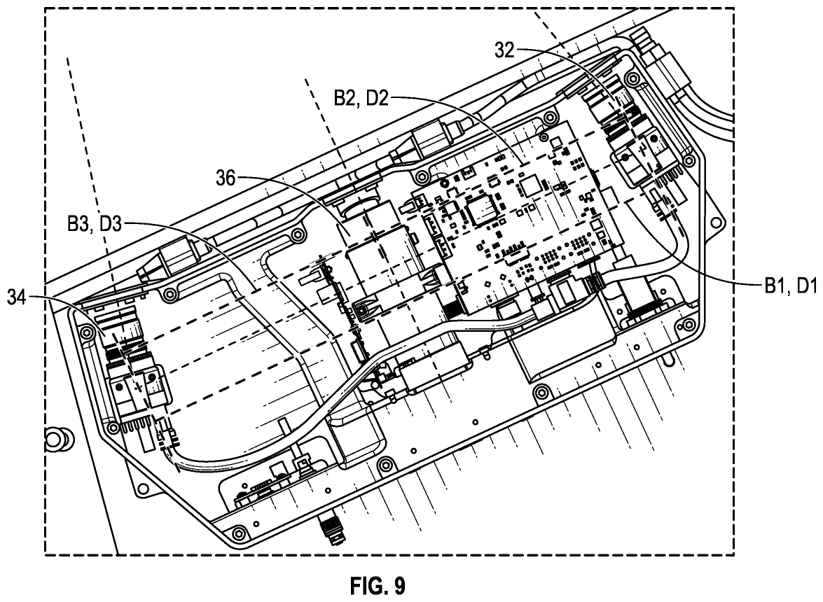

Since the passenger side measurement device 20 and the driver side measurement device 22 are mirror images of each other with respect to the inspection device 12, further description of the specific baselines will only be described with respect to the passenger side measurement device 20 for ease of understanding. For example, with reference to FIGS. 4 and 8-9, the first passenger side camera 32 and the second passenger side camera 34 are spaced apart from one another and the passenger side light source 36 is positioned between them. The first passenger side camera 32 and the second passenger side camera 34 point forward in the direction of the structured illumination 86 projected by the passenger side light source 36 and are angularly offset with respect to the passenger side light source 36. In particular, the first passenger side camera 32, the second passenger side camera 34, and the passenger side light source 36 are positioned with respect to three specific baselines. The first baseline B1 is the distance D1 between the first passenger side camera 32 and the second passenger side camera 34. The second baseline B2 is the distance D2 between the first passenger side camera 32 and the passenger side light source 36. The third baseline B3 is the distance D3 between the second passenger side camera 34 and the passenger side light source 36. As the first passenger side camera 32 and the second passenger side camera 34 are angled inwardly towards the passenger side light source 36, the chief light rays of each of the first passenger side camera 32, the second passenger side camera 34, and the passenger side light source 36 converge such that: the chief light rays of the first passenger side camera 32 and the second passenger side camera 34 along with the first baseline B1 form a first triangle T1 having a first angle A1; the chief light rays of the first passenger side camera 32 and the passenger side light source 36 along with the second baseline B2 form a second triangle T2 having a second angle A2; and the chief light rays of the second passenger side camera 34 and the passenger side light source 36 along with third baseline B3 form a third triangle T3 having a third angle A3. The first through third triangles T1-T3 allow for three, independent 3D surface reconstructions to be performed on each image pair using trigonometric triangulation for each image.

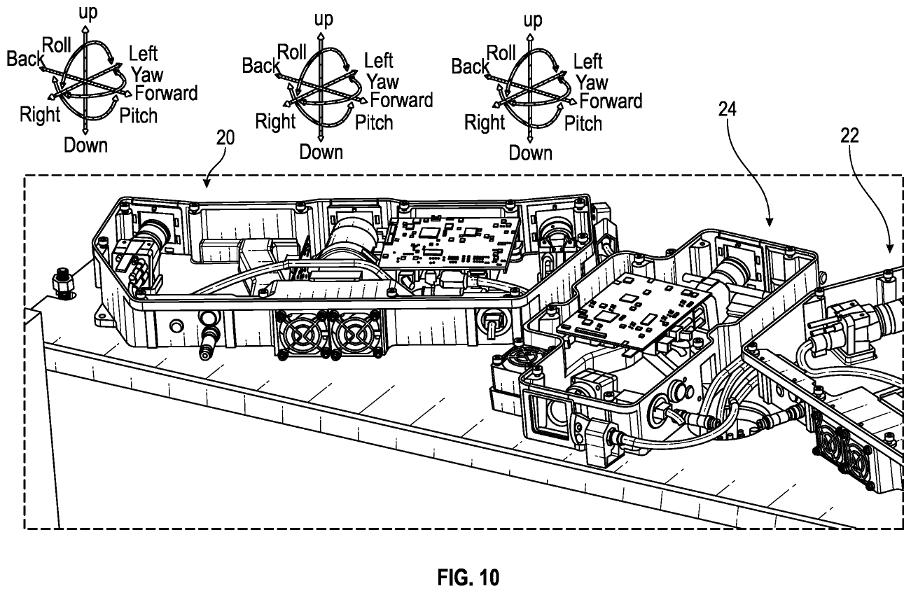

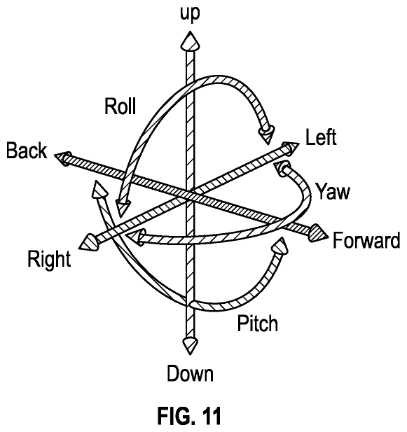

Because the specific positions of the first passenger side camera 32, the second passenger side camera 34, and the passenger side light source 36, relative to each other, may fluctuate as a function of temperature within the passenger side measurement device 20, an alternative calibration procedure can be implemented to ensure that the structured illumination 86 is properly projected and that the structured illumination 86 projected onto the tires of the vehicle are properly captured. For example, as the temperature within the passenger side measurement device 20 changes, thermal expansion and contraction will create changes in the first through third baselines B1-B3 and the first through third angles A1-A3 of the first through third triangles T1-T3. As depicted in FIGS. 10 and 11, such changes will occur in three dimensions (rotations and translation in multiple dimensions) with a total of six degrees of freedom. The calibration procedure determines the relative positions of the first passenger side camera 32, the second passenger side camera 34, and the passenger side light source 36 for creating accurate 3D reconstruction and, hence, determine accurate tire tread depth measurements.

In a preferred calibration procedure, the approach is to calibrate over a range of temperatures and create calibration factors associated with temperatures within this range. During operation, the appropriate calibration factors can then be applied based on the current operational temperature. For example, the inspection device 12 can be calibrated at an operating range of −20° C. to 40° C. or any other desired temperature range. The internal temperature of passenger side measurement device 20 (similarly, for the driver side measurement device 22 and the license plate reader 24) can be monitor and calibration performed based on the internal temperature.

Alternatively, another calibration approach is to calibrate at a known temperature and ensure, through a complex heating and cooling system, that the critical components within the passenger side measurement device, for example, do not undergo an appreciable shift during operation (e.g., maintain the internal temperature at a desired temperature).

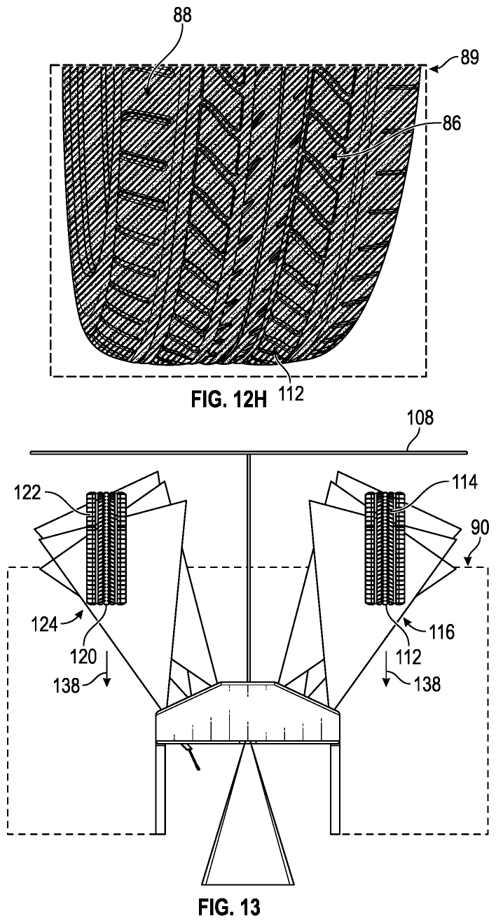

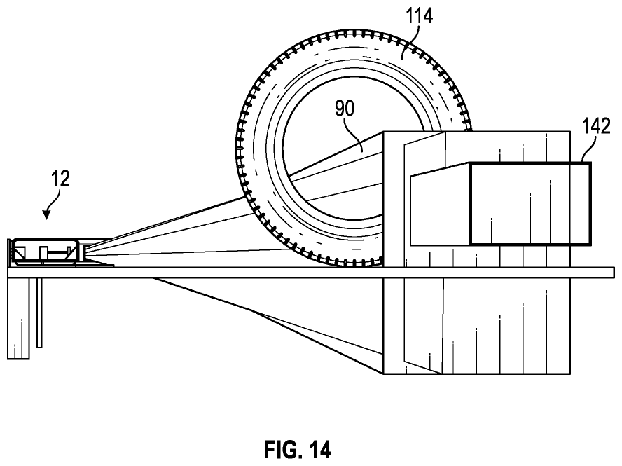

With reference to FIGS. 13 and 14, in operation, the passenger side time of flight sensor 44 and/or the driver side time of flight sensor 52 continually interrogates a field of view 90 at a target distance range until an object is detected. In certain aspects, the field of view 90 can be, but is not limited to, approximately 600 meters by 600 millimeters. In certain aspects the target distance range can, but is not limited to, approximately 1000 millimeters to 12000 millimeters. As the vehicle approaches the inspection device 12, the passenger side time of flight sensor 44 and/or the driver side time of flight sensor 52 can detect and determine that the vehicle has passed into the field of view 90, and initiate a trigger signal 110 simultaneously transmitted to each of the first and second passenger side cameras 32, 34, the passenger side light source 36, the first and second driver side cameras 38, 40, and the driver side light source 42. Responsive to the trigger signal 110, the passenger side light source 36 and the driver side light source 42 each project the structured illumination 86 onto respective passenger side tires and driver side tires of the moving vehicle while, simultaneously, the first and second passenger side cameras 32, 34 and the first and second driver side cameras 38, 40 capture a plurality of images of the passenger side tires and the driver side tires with the structured illumination 86 projected thereon over a period of time. In certain aspects, the first and second passenger side cameras 32, 34 and the first and second driver side cameras 38, 40 capture approximately 15 images each over a period of time that ranges from 0.1 seconds to 0.5 seconds. It should be understood that other amounts of images and different periods of time are within the scope of the present disclosure. While the above describes the passenger side time of flight sensor 44 and/or the driver side time of flight sensor 52 as the triggering mechanism to actuate each of the first and second passenger side cameras 32, 34, the passenger side light source 36, the first and second driver side cameras 38, 40, and the driver side light source 42, it should be understood that other triggering mechanism are well within the scope of the present disclosure.

For example, in certain aspects, instead of either the passenger side time of flight sensor 44 or the driver side time of flight sensor 52, a pressure sensor 108 (see FIG. 13) is utilized as the triggering mechanism to actuate each of the first and second passenger side cameras 32, 34, the passenger side light source 36, the first and second driver side cameras 38, 40, and the driver side light source 42. The pressure sensor 108 can be in wireless, or wired, communication with the first and second passenger side cameras 32, 34, the passenger side light source 36, the first and second driver side cameras 38, 40, and the driver side light source 42. The pressure sensor 108 can be, but is not limited to, a pressure sensing cable. The pressure sensor 108 can be positioned on the floor such that a vehicle will drive over the pressure sensor 108 initiating transmission of the trigger signal 110 to each of the first and second passenger side cameras 32, 34, the passenger side light source 36, the first and second driver side cameras 38, 40, and the driver side light source 42. Responsive to receiving the trigger signal 110, the passenger side light source 36 and the driver side light source 42 each project the structured illumination 86 onto respective passenger side tires and driver side tires of the moving vehicle while, simultaneously, the first and second passenger side cameras 32, 34 and the first and second driver side cameras 38, 40 capture a plurality of images of the passenger side tires and the driver side tires with the structured illumination 86 projected thereon over a period of time. For example, the first and second passenger side cameras 32, 34 and the first and second driver side cameras 38, 40 may capture approximately 15 images each over a period of time that ranges from 0.1 seconds to 0.5 seconds. In certain aspects, the first and second passenger side cameras 32, 34 and the first and second driver side cameras 38, 40 capture images for a predetermined period of time at a predetermined, where both the period of time and the rate can be fixed or variable. In other aspects, the first and second passenger side cameras 32, 34 and the first and second driver side cameras 38, 40 capture images until optimal images of the passenger side tires and the driver side tires are found, as described below. In yet other aspects, a variable delay may be implemented after triggering to facilitate/calibrate positioning of the tire relative to the measure zones 140, 142 during setup of the inspection device 12.

After all the images are captured, the images are processed to determine, from each image pair that the first and second passenger side cameras 32, 34 captured and from each image pair that the first and second driver side cameras 38, 40 captured, the best focused image pairs. In certain aspects, the best focused image pair is determined using an image modulation transfer function (MTF). To ensure that the best focused image pairs actually captured tires, the best focused image pair are further processed to determine that a vehicle is present in the best focused image pairs. With the best focused image pairs determined, a 3D surface of the passenger side tire and the driver side tire is reconstructed based on the best focused image pairs. The 3D reconstruction of the passenger side tire and the driver side tire is then processed to extract the tire tread depth of each tire. In certain aspects, the tire tread depth is determined using a convex hull algorithm.

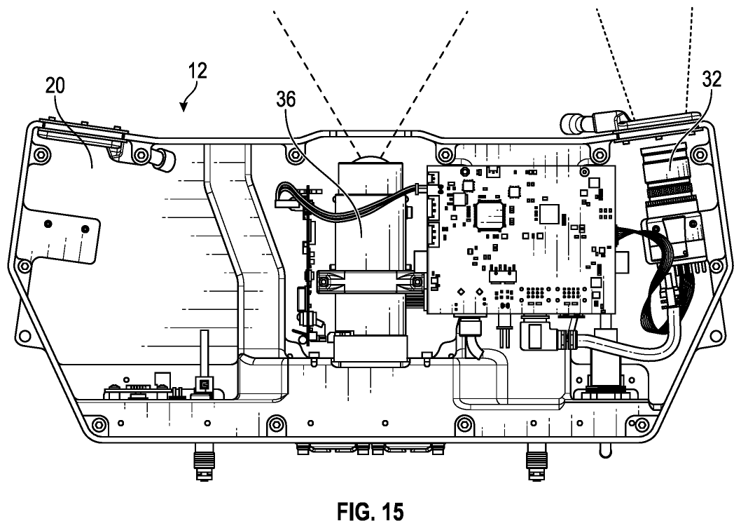

FIG. 15 illustrates an alternative embodiment of the passenger side measurement device 20 of the inspection device 12 in which the passenger side measurement device 20 includes one passenger side camera (e.g., instead of two cameras) and one passenger side light source and the driver side measurement device 22 includes one driver side camera (e.g., instead of two cameras) and one driver side light source. In certain aspects, the driver side measurement device 22 of the inspection device 12 can be similarly configured.

In certain aspects, the contactless tire inspection apparatus 12 includes the driver side measurement device 22 and the passenger side measurement device 20. The driver side measurement device 22 and the passenger side measurement device 20 are spaced apart in a lateral direction and oriented in a common plane. The driver side measurement device 22 includes the driver side light source 42 configured to, responsive to receiving a trigger signal 110, project a first structured illumination 86 onto an area of tread 112 of a driver side tire 114 of a vehicle at a first measurement location 116 forwardly and laterally displaced from the driver side measurement device 22 and at least one driver side camera 38 configured to, responsive to receiving the trigger signal 110, capture one or more driver side images 118 of the first structured illumination projected 86 onto the driver side tire 114 for 3D reconstruction. The passenger side measurement device 20 includes a passenger side light source 36 configured to, responsive to receiving the trigger signal 110, project a second structured illumination 86 onto an area of tread 120 of a passenger side tire 122 of the vehicle at a second measurement location 124 forwardly and laterally displaced from the passenger side measurement device 20 and at least one passenger side camera 32 configured to, responsive to receiving the trigger signal 110, capture one or more passenger side images 126 of the second structured illumination 86 projected onto the passenger side tire 122 for 3D reconstruction when the least one driver side camera 38 captures one or more driver side images 118 of the first structured illumination 86 projected onto the driver side tire 114.

In certain aspects, the first measurement location 116 is forwardly and laterally outwardly displaced from the driver side measurement device 22 and the second measurement location 124 is forwardly and laterally displaced from the driver side measurement device 22.

In certain aspects, the first structured illumination 86 and the second structured illumination 86 are LED light patterns comprising an infrared wavelength.

In certain aspects, the contactless tire inspection apparatus 12 further includes a time of flight sensor 52 configured to monitor a field of view 90 and initiate transmission of the trigger signal 110, based on detecting the vehicle passing into the field of view 90, to the driver side measurement device 22 and the passenger side measurement device 20.

In certain aspects, at least one of the driver side measurement device 22 and the passenger side measurement device 20 is in communication with a pressure sensor 108 configured to detect the vehicle applying pressure thereto and initiate transmission of the trigger signal 110, based on detecting the vehicle applying pressure thereto, to the at least one of the driver side measurement device 22 and the passenger side measurement device 20.

In certain aspects, the contactless tire inspection apparatus 12 further includes a license plate reader 24 configured to, in response to receiving the trigger signal 110, identify a license plate of the vehicle.

In certain other aspects, a contactless tire inspection apparatus 12 for tire tread depth measurement using 3D reconstruction is provided. The contactless tire inspection apparatus 12 comprises a driver side measurement device 22, a passenger side measurement device 20, and a housing 16. The housing 16 is configured to house the driver side measurement device 22 and the passenger side measurement device 20 therein. The driver side measurement device 22 and the passenger side measurement device 20 are spaced apart in a width dimension 128 of the housing 16 and oriented in a common plane. The driver side measurement device 22 faces forwardly in a first direction 130 angularly offset from perpendicular to the width dimension 128 by a first angle 132 and the passenger side measurement device 20 faces forwardly in a second direction 134 angularly offset from perpendicular to the width dimension 128 by a second angle 136. The driver side measurement device 22 includes a driver side light source 42 configured to, responsive to receiving a trigger signal 110, project a first structured illumination 86 onto an area of tread 112 of a driver side tire 114 of the vehicle at a first measurement location 116 outwardly displaced from the housing 16 along the first direction 130 and at least one driver side camera 38 configured to, responsive to receiving the trigger signal 110, capture one or more driver side images 118 of the first structured illumination 86 projected onto the driver side tire 114 for 3D reconstruction. The passenger side measurement device 20 includes a passenger side light source 36 configured to, responsive to receiving the trigger signal 110, project a second structured illumination 86 onto an area of tread 120 of a passenger side tire 122 of the vehicle at a second measurement location 124 outwardly displaced from the housing along the second direction 134 and at least one passenger side camera 32 configured to, responsive to receiving the trigger signal 110, capture one or more passenger side images 126 of the second structured illumination 86 projected onto the passenger side tire 122 for 3D reconstruction when the least one driver side camera 38 captures one or more driver side images 118 of the first structured illumination 86 projected onto the driver side tire 114.

In certain aspects, the first angle 132 is a positive angle and the second angle 136 is a negative angle.

In certain aspects, the first angle 132 and the second angle 136 are congruent angles.

In certain aspects, the first structured illumination 86 and the second structured illumination 86 are LED light patterns comprising an infrared wavelength.

In another aspect, a contactless tire inspection apparatus 12 for tire tread depth measurement using 3D reconstruction is provided. The contactless tire inspection apparatus 12 comprises the driver side measurement device 22, the passenger side measurement device 20, and the housing 16. The housing 16 is housing configured to house the driver side measurement device 22 and the passenger side measurement device 20 therein. The driver side measurement device 22 and the passenger side measurement device 20 are spaced apart in the width dimension 128 of the housing 16 and oriented in a common plane. The driver side measurement device 22 includes a driver side light source 42 configured to, responsive to receiving the trigger signal 110, project a first structured illumination 86 onto an area of tread 112 of a driver side tire 114 of the vehicle at a first measurement location 116 outwardly displaced from the housing 16 and at least one driver side camera 38 configured to, responsive to receiving the trigger signal 110, capture one or more driver side images 118 of the first structured illumination 86 projected onto the driver side tire 114 for 3D reconstruction. The passenger side measurement device 20 includes a passenger side light source 36 configured to, responsive to receiving the trigger signal 110, project a second structured illumination 86 onto the area of tread 120 of the passenger side tire 122 of the vehicle at the second measurement location 124 outwardly displaced from the housing 16 and at least one passenger side camera 32 configured to, responsive to receiving the trigger signal 110, capture one or more passenger side images 126 of the second structured illumination 86 projected onto the passenger side tire 122 for 3D reconstruction. The housing 16 has a low-profile to allow placement in a travel path 138 of the vehicle that includes the first measurement location 116 and the second measurement location 124 without contact with the vehicle.

In certain aspects, the driver side measurement device faces 22 forwardly in the first direction 130 angularly offset from perpendicular to the width dimension 128 by the first angle 132 and the passenger side measurement device 20 faces forwardly in the second direction 134 angularly offset from perpendicular to the width dimension 128 by a second angle 136.

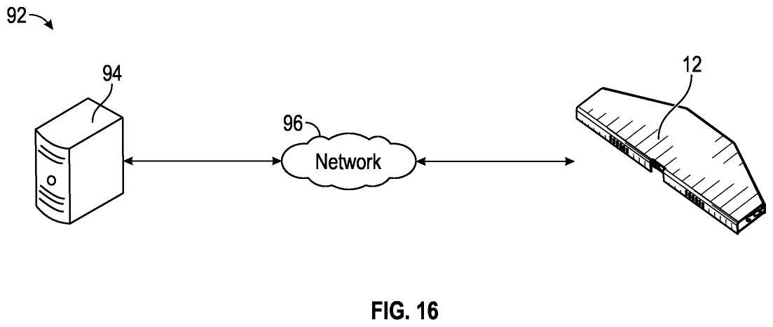

FIG. 16 illustrates an example architecture 92 for contactless tire inspection. The architecture 92 includes a server 94 and the inspection device 12 connected over a network 96. As described above, the inspection device 12 is located at a leading edge or entrance of the service pit 14 from which a vehicle approaches. In certain aspects, the server 964 is located on site in the vicinity of the service pit 14. In other aspects, the server 94 can be a cloud computing server of an infrastructure-as-a-service (IaaS) and be able to support a platform-as-a service (PaaS) and software-as-a-service (SaaS) services.

The server 94 can be any device having an appropriate processor, memory, and communication capability for receiving, transmitting, and processing any of the functions described above. The inspection device 12 can be any device having an appropriate processor, memory, and communication capability for receiving, transmitting, and processing any of the functions described above. The functions described above can be performed on the server 94, on the inspection device 12, or a combination of both.

The network 96 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

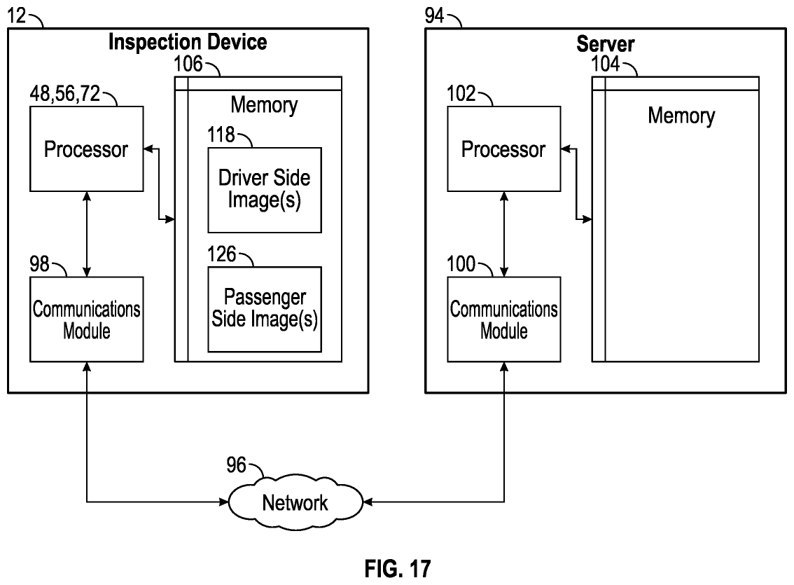

FIG. 17 is a block diagram illustrating the server 94 and the inspection device 12 in the architecture 92 of FIG. 16 according to certain aspects of the disclosure.

The inspection device 12 and the server 94 are connected over the network 96 via respective communications modules 98, 100. The communication module 98 of the inspection device 12 can be disposed in the passenger side measurement device 20, the driver side measurement device 22, and/or the license plate reader 24, individually or in any combination. The communication modules 98, 100 are configured to interface with the network 96 to send and receive information, such as data, requests, responses, and commands to other devices on the network 96. The communications modules 98, 100 can be, for example, modems or Ethernet cards.

The server 94 includes a processor 102, the communications module 100, and a memory 104. The processor 102 of the server 94 is configured to execute instructions, such as instructions physically coded into the processor 102 instructions received from the software in the memory 104, or a combination of both. In certain aspects, the processor 102 of the server 94 is configured to receive the captured images from the inspection device 12, and process the images from each image pair that the first and second passenger side cameras 32, 34 captured and from each image pair that the first and second driver side cameras 38, 40 captured to determine the best focused image pairs. The processor 102 the server 94 is configured to, based on the best focused image pairs, generate the 3D surface of the passenger side tire and the driver side tire, respectively. The processor 102 of the server 94 is configured to extract the tire tread depth of each of the passenger side tire and the driver side tire from the generated 3D surface of the tires. The processor 102 of the server 94 is configured to generate a report including at least the tire tread depth of each of the passenger side tire and the driver side tire. In certain aspects, the report is formatted into a CSV file, but other file formats are certainly within the scope of the present disclosure.

The inspection device 12 includes the communications module 98 and a memory 106, which can be disposed in the passenger side measurement device 20, the driver side measurement device 22, and/or the license plate reader 24, individually or in any combination. The inspection device 12 also includes the passenger side processor 48 of the passenger side measurement device 20, the driver side processor 56 of the driver side measurement device 22, and the license plate reader processor 72 of the license plate reader 24. The passenger side processor 48, the driver side processor 56, and/or the license plate reader processor 72, individually or in any combination, are configured to execute instructions, such as instructions physically coded into the passenger side processor 48, the driver side processor 56, and/or the license plate reader processor 72, instructions received from software in memory 106, or a combination of both.

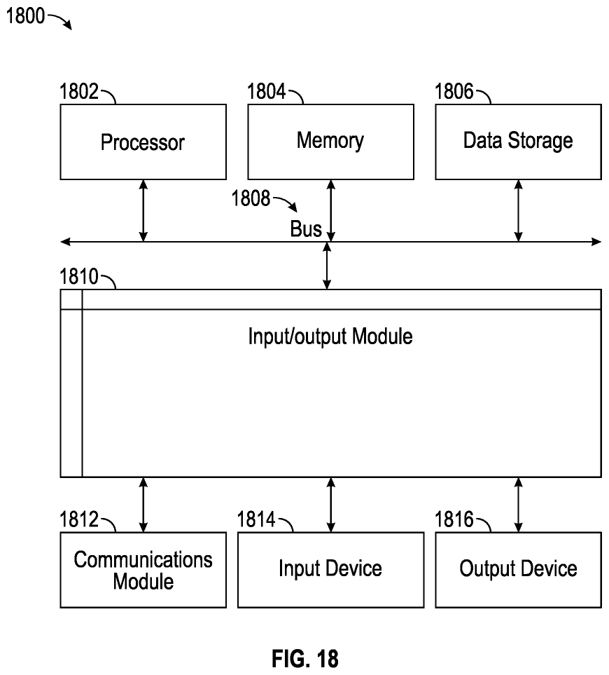

FIG. 18 is a block diagram illustrating an example computer system 1800 with which the inspection device 12 and the server 94 of FIG. 17 can be implemented. In certain aspects, the computer system 1800 may be implemented using hardware or a combination of software and hardware, either in a dedicated server, or integrated into another entity, or distributed across multiple entities.

Computer system 1800 (e.g., the inspection device 12 and the server 94) includes a bus 1808 or other communication mechanism for communicating information, and a processor 1802 (e.g., the processors 48, 56, 72, 102) coupled with bus 1808 for processing information. According to one aspect, the computer system 1800 can be a cloud computing server of an IaaS that is able to support PaaS and SaaS services.

Computer system 1800 can include, in addition to hardware, code that creates an execution environment for the computer program in question, e.g., code that constitutes processor firmware, a protocol stack, a database management system, an operating system, or a combination of one or more of them stored in an included memory 1804 (e.g., the memory 104, 106), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 1808 for storing information and instructions to be executed by processor 1802. The processor 1802 and the memory 1804 can be supplemented by, or incorporated in, special purpose logic circuitry.

The instructions may be stored in the memory 1804 and implemented in one or more computer program products, e.g., one or more modules of computer program instructions encoded on a computer readable medium for execution by, or to control the operation of, the computer system 1800.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network, such as in a cloud-computing environment. The processes and logic flows described in this specification can be performed by one or more programmable processors executing one or more computer programs to perform functions by operating on input data and generating output.

Computer system 1800 further includes a data storage device 1806 such as a magnetic disk or optical disk, coupled to bus 1808 for storing information and instructions. Computer system 1800 may be coupled via input/output module 1810 to various devices. The input/output module 1810 can be any input/output module. Example input/output modules 1810 include data ports such as USB ports. In addition, input/output module 1810 may be provided in communication with processor 1802, so as to enable near area communication of computer system 1800 with other devices. The input/output module 1810 may provide, for example, for wired communication in some implementations, or for wireless communication in other implementations, and multiple interfaces may also be used. The input/output module 1810 is configured to connect to a communications module 1812. Example communications modules 1812 (e.g., the communications module 98, 100) include networking interface cards, such as Ethernet cards and modems.

In certain aspects, the input/output module 1810 is configured to connect to a plurality of devices, such as an input device 1814 and/or an output device 1816. Example input devices 1814 include a keyboard and a pointing device, e.g., a mouse or a trackball, by which a user can provide input to the computer system 1800. Other kinds of input devices 1814 can be used to provide for interaction with a user as well, such as a tactile input device, visual input device, audio input device, or brain-computer interface device.

According to one aspect of the present disclosure the inspection device 12 and the server 94, can be implemented using a computer system 1800 in response to processor 1802 executing one or more sequences of one or more instructions contained in memory 1804. Such instructions may be read into memory 1804 from another machine-readable medium, such as data storage device 1806. Execution of the sequences of instructions contained in main memory 1804 causes processor 1802 to perform the process steps described herein. One or more processors in a multi-processing arrangement may also be employed to execute the sequences of instructions contained in memory 1804. Processor 1802 may process the executable instructions and/or data structures by remotely accessing the computer program product, for example by downloading the executable instructions and/or data structures from a remote server through communications module 1812 (e.g., as in a cloud-computing environment). In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. For example, some aspects of the subject matter described in this specification may be performed on a cloud-computing environment. Accordingly, in certain aspects a user of systems and methods as disclosed herein may perform at least some of the steps by accessing a cloud server through a network connection. Further, data files, circuit diagrams, performance specifications and the like resulting from the disclosure may be stored in a database server in the cloud-computing environment, or may be downloaded to a private storage device from the cloud-computing environment.

The term “machine-readable storage medium” or “computer-readable medium” as used herein refers to any medium or media that participates in providing instructions or data to processor 1802 for execution. The term “storage medium” as used herein refers to any non-transitory media that store data and/or instructions that cause a machine to operate in a specific fashion. Such a medium may take many forms, including, but not limited to, non-volatile media, volatile media, and transmission media.

As used in this specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire and fiber optics, including the wires that comprise bus 1808. Transmission media can also take the form of acoustic or light waves, such as those generated during radio-wave and infra-red data communications. Furthermore, as used in this specification of this application, the terms “computer”, “server”, “processor”, and “memory” all refer to electronic or other technological devices. These terms exclude people or groups of people. For the purposes of the specification, the terms display or displaying means displaying on an electronic device.

In one aspect, a method may be an operation, an instruction, or a function and vice versa. In one aspect, a clause or a claim may be amended to include some or all of the words (e.g., instructions, operations, functions, or components) recited in either one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. §112, sixth paragraph, unless the element is expressly recited using the phrase “means for” or, in the case of a method claim, the element is recited using the phrase “step for”.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A contactless tire inspection apparatus for tire tread depth measurement using 3D reconstruction, the apparatus comprising:
a driver side measurement device; and
a passenger side measurement device,
the driver side measurement device and the passenger side measurement device being spaced apart in a lateral direction and oriented in a common plane,
the driver side measurement device including a driver side light source configured to, responsive to receiving a trigger signal, project a first structured illumination onto an area of tread of a driver side tire of a vehicle at a first measurement location forwardly and laterally displaced from the driver side measurement device and at least one driver side camera configured to, responsive to receiving the trigger signal, capture one or more driver side images of the first structured illumination projected onto the driver side tire for 3D reconstruction, and
the passenger side measurement device including a passenger side light source configured to, responsive to receiving the trigger signal, project a second structured illumination onto an area of tread of a passenger side tire of the vehicle at a second measurement location forwardly and laterally displaced from the passenger side measurement device and at least one passenger side camera configured to, responsive to receiving the trigger signal, capture one or more passenger side images of the second structured illumination projected onto the passenger side tire for 3D reconstruction when the at least one driver side camera captures one or more driver side images of the first structured illumination projected onto the driver side tire.

2. The apparatus of claim 1, wherein the first measurement location is forwardly and laterally outwardly displaced from the driver side measurement device and the second measurement location is forwardly and laterally displaced from the driver side measurement device.

3. The apparatus of claim 1, wherein the first structured illumination and the second structured illumination are LED light patterns comprising an infrared wavelength.

4. The apparatus of claim 1, further comprising a time of flight sensor configured to monitor a field of view and initiate transmission of the trigger signal, based on detecting the vehicle passing into the field of view, to the driver side measurement device and the passenger side measurement device.

5. The apparatus of claim 1, wherein at least one of the driver side measurement device and the passenger side measurement device is in communication with a pressure sensor configured to detect the vehicle applying pressure thereto and initiate transmission of the trigger signal, based on detecting the vehicle applying pressure thereto, to the at least one of the driver side measurement device and the passenger side measurement device.

6. The apparatus of claim 1, further comprising a license plate reader configured to, in response to receiving the trigger signal, identify a license plate of the vehicle.

7. A contactless tire inspection apparatus for tire tread depth measurement using 3D reconstruction, the apparatus comprising:
a driver side measurement device;
a passenger side measurement device; and
a housing configured to house the driver side measurement device and the passenger side measurement device therein, the driver side measurement device and the passenger side measurement device being spaced apart in a width dimension of the housing and oriented in a common plane, the driver side measurement device facing forwardly in a first direction angularly offset from perpendicular to the width dimension by a first angle and the passenger side measurement device facing forwardly in a second direction angularly offset from perpendicular to the width dimension by a second angle,
the driver side measurement device including a driver side light source configured to, responsive to receiving a trigger signal, project a first structured illumination onto an area of tread of a driver side tire of the vehicle at a first measurement location outwardly displaced from the housing along the first direction and at least one driver side camera configured to, responsive to receiving the trigger signal, capture one or more driver side images of the first structured illumination projected onto the driver side tire for 3D reconstruction, and
the passenger side measurement device including a passenger side light source configured to, responsive to receiving the trigger signal, project a second structured illumination onto an area of tread of a passenger side tire of the vehicle at a second measurement location outwardly displaced from the housing along the second direction and at least one passenger side camera configured to, responsive to receiving the trigger signal, capture one or more passenger side images of the second structured illumination projected onto the passenger side tire for 3D reconstruction when the at least one driver side camera captures one or more driver side images of the first structured illumination projected onto the driver side tire.

8. The apparatus of claim 7, wherein the first angle is a positive angle and the second angle is a negative angle.

9. The apparatus of claim 7, wherein the first angle and the second angle are congruent angles.

10. The apparatus of claim 7, wherein the first structured illumination and the second structured illumination are LED light patterns comprising an infrared wavelength.

11. The apparatus of claim 7, further comprising a time of flight sensor configured to monitor a field of view and initiate transmission of the trigger signal, based on detecting the vehicle passing into the field of view, to the driver side measurement device and the passenger side measurement device.

12. The apparatus of claim 7, wherein at least one of the driver side measurement device and the passenger side measurement device is in communication with a pressure sensor configured to detect the vehicle applying pressure thereto and initiate transmission of the trigger signal, based on detecting the vehicle applying pressure thereto, to the at least one of the driver side measurement device and the passenger side measurement device.

13. The apparatus of claim 7, further comprising a license plate reader configured to, in response to receiving the trigger signal, identify a license plate of the vehicle.

14. A contactless tire inspection apparatus for tire tread depth measurement using 3D reconstruction, the apparatus comprising:
a driver side measurement device;
a passenger side measurement device; and
a housing configured to house the driver side measurement device and the passenger side measurement device therein, the driver side measurement device and the passenger side measurement device being spaced apart in a width dimension of the housing and oriented in a common plane,
the driver side measurement device including a driver side light source configured to, responsive to receiving a trigger signal, project a first structured illumination onto an area of tread of a driver side tire of the vehicle at a first measurement location outwardly displaced from the housing and at least one driver side camera configured to, responsive to receiving the trigger signal, capture one or more driver side images of the first structured illumination projected onto the driver side tire for 3D reconstruction, and
the passenger side measurement device including a passenger side light source configured to, responsive to receiving the trigger signal, project a second structured illumination onto an area of tread of a passenger side tire of the vehicle at a second measurement location outwardly displaced from the housing and at least one passenger side camera configured to, responsive to receiving the trigger signal, capture one or more passenger side images of the second structured illumination projected onto the passenger side tire for 3D reconstruction,
wherein the housing has a low-profile to allow placement in a travel path of the vehicle that includes the first measurement location and the second measurement location without contact with the vehicle.

15. The apparatus of claim 14, wherein the first structured illumination and the second structured illumination are LED light patterns comprising an infrared wavelength.

16. The apparatus of claim 14, further comprising a time of flight sensor configured to monitor a field of view and initiate transmission of the trigger signal, based on detecting the vehicle passing into the field of view, to the driver side measurement device and the passenger side measurement device.

17. The apparatus of claim 14, wherein at least one of the driver side measurement device and the passenger side measurement device is in communication with a pressure sensor configured to detect the vehicle applying pressure thereto and initiate transmission of the trigger signal, based on detecting the vehicle applying pressure thereto, to the at least one of the driver side measurement device and the passenger side measurement device.

18. The apparatus of claim 14, further comprising a license plate reader configured to, in response to receiving the trigger signal, identify a license plate of the vehicle.

19. The apparatus of claim 14, wherein the driver side measurement device faces forwardly in a first direction angularly offset from perpendicular to the width dimension by a first angle and the passenger side measurement device faces forwardly in a second direction angularly offset from perpendicular to the width dimension by a second angle.

20. The apparatus of claim 19, wherein the first measurement location is forwardly and laterally outwardly displaced from the driver side measurement device and the second measurement location is forwardly and laterally displaced from the driver side measurement device.
